(19) United States
(12) Patent Application Publication
(10) Pub. No.: US 2010/0318614 A1
(43) Pub. Date: Dec. 16, 2010

(54) Displaying User Profile and Reputation with a Communication Message

(76) Inventors: Florian Clemens SAGER, Munich (DE); Bernhard Heindl, Prien am Chiemsee (DE); Christian Heindl, Munich (DE)

Correspondence Address: CLIFFORD B. PERRY, 270 N. El Camino Real, No. F-347, ENCINITAS, CA, 92024, US

(21) Appl. No.: 12/483,427

(22) Filed: Jun. 12, 2009

(51) Int. Cl. G06F 15/16

(52) U.S. Cl. 709/206

(57) ABSTRACT

A method of coordinating communication between a sender entity sending a communication message and a recipient entity receiving the communication message over a communication network, wherein the method comprises registering the sender entity based on registration data indicative of an identity of the sender entity and comprising assigned user profile data of the sender entity, determining a reputation of the sender entity based on the identity, and transmitting the user profile data and the reputation to the recipient entity for display of the user profile data and the reputation together with the communication message, the transmitting being triggered in response to a request of the recipient entity including the identity.

The invention relates to a coordination entity.

Moreover, the invention relates to a sender entity.

The invention furthermore relates to a recipient entity.

The invention further relates to a communication system.

Moreover, the invention relates to a communication method.

Beyond this, the invention relates to a program element.

The invention further relates to a computer-readable medium.

Internet-based communication systems involve the exchange of electronic communication messages between different users operating different computers.

U.S. Pat. No. 7,457,955 discloses a trusted branded email method and an apparatus which detects branded electronic messages and performs validation before it is sent to a recipient. In another aspect, an electronic message is branded by embedding branding assets and cryptographic signatures. Branding assets are presented to a user using a distinct indicia that represents to the user that the branding assets are authentic.

Communication over a communication network may still lack security and trustability.

It is an object of the invention to enable a communication system to be operable with reasonable security and trustability.

In order to achieve the object defined above, a coordination entity, a sender entity, a recipient entity, a communication system, a communication method, a program element, and a computer-readable medium according to the independent claims are provided.

According to an exemplary embodiment of the invention, a coordination entity (for instance a coordination server computer) for coordinating communication between a sender entity (for instance a sender computer and/or a communication message server (such as an email server) communicatively coupled to a sender computer) sending a communication message and a recipient entity (for instance a recipient computer and/or a communication message server (such as an email server) communicatively coupled to a recipient computer) receiving the communication message over a communication network is provided, the coordination entity comprising a registration receipt unit configured for receiving registration data from the sender entity indicative of an identity of the sender entity (for instance an identity of a sender computer and/or an identity of a communication message server (such as an email server) communicatively coupled to a sender computer) and comprising assigned user profile data of the sender entity, a determining unit configured for determining a reputation of the sender entity (particularly by querying a reputation database) based on the identity, and a user data transmission unit configured for transmitting the user profile data and the reputation to the recipient entity for display of the user profile data and the reputation together with the communication message, the transmitting being triggered in response to a request of the recipient entity including the identity.

According to another exemplary embodiment of the invention, a sender entity for sending a communication message to a recipient entity over a communication network is provided, the sender entity (particularly a previous behaviour of the sender entity) being characterized in the communication network by a reputation (particularly stored in a reputation database and assigned to the sender entity via the identity), the sender entity comprising a registration trigger unit configured for triggering a registration of the sender entity by sending registration data indicative of an identity of the sender entity and comprising assigned user profile data of the sender entity to a coordination entity to enable the coordination entity for determining the reputation of the sender entity (particularly by querying the reputation database) based on the identity and for transmitting the user profile data and the reputation to the recipient entity for display of the user profile data and the reputation together with the communication message, and a message sending unit for sending the communication message including the identity to the recipient entity.

According to still another exemplary embodiment of the invention, a recipient entity for receiving a communication message from a sender entity over a communication network is provided, the recipient entity comprising a message receiver unit configured for receiving the communication message from the sender entity including an identity of the sender entity, a request unit configured for sending a request for user profile data and a reputation of the sender entity to a coordination entity, the request including the identity of the sender entity, a user data receiver unit configured for receiving the user profile data and the reputation of the sender entity from the coordination entity in response to the request to the coordination entity, and a display unit configured for displaying the user profile data and the reputation together with the communication message.

According to yet another exemplary embodiment of the invention, a communication system for communicating over a communication network is provided, the communication system comprising a sender entity having the above mentioned features for sending a communication message to a recipient entity over the communication network, the recipient entity having the above mentioned features for receiving the communication message from the sender entity over the communication network, and a coordination entity having the above mentioned features and coordinating communication between the sender entity and the recipient entity over the communication network.

The various units in the above mentioned embodiments may be processors or may form part of a processor. Furthermore, the various units in the above mentioned embodiments may comprise storage resources or may have access to storage resources.

According to still another exemplary embodiment of the invention, a method of coordinating communication between a sender entity sending a communication message and a recipient entity receiving the communication message over a communication network is provided, wherein the method comprises registering the sender entity based on registration data indicative of an identity of the sender entity and comprising assigned user profile data of the sender entity, determining a reputation of the sender entity (particularly by querying a reputation database) based on the identity, and transmitting the user profile data and the reputation to the recipient entity for display of the user profile data and the reputation together with the communication message, the transmitting being triggered in response to a request of the recipient entity including the identity.

According to still another exemplary embodiment of the invention, a program element (for instance a software routine, in source code or in executable code) is provided, which, when being executed by a processor (such as a microprocessor or a CPU), is adapted to control or carry out a method having the above mentioned features.

According to yet another exemplary embodiment of the invention, a computer-readable medium (for instance a CD, a DVD, a USB stick, a floppy disk or a harddisk) is provided, in which a computer program is stored which, when being executed by a processor (such as a microprocessor or a CPU), is adapted to control or carry out a method having the above mentioned features.

Data processing which may be performed according to embodiments of the invention can be realized by a computer program, that is by software, or by using one or more special electronic optimization circuits, that is in hardware, or in hybrid form, that is by means of software components and hardware components.

In the context of this application, the term “user profile data” may particularly denote displayable information giving an observer of the displayed data an impression regarding the identity and at least one property of the user. Hence, the profile data may render the user a round character for the observer. Such user profile data may include text and/or multimedia components describing the user. The user profile data may be related to the person operating the sender entity and may thus be in connection with a real person. However, it is also possible that the profile maps an abstract identity, for instance relates to a support department of a company to which the sender entity or the person operating the sender entity belongs.

The term “reputation” or “reputation data” may particularly denote data or an information indicative of a probability whether a sender of a communication message can be considered as a trusted communication party or has to be considered as a (for instance potentially or definitely) untrusted communication party (for instance if there is a reasoned assumption that such a communication party might send or have sent spam messages, undesired advertisement, phishing messages, a computer virus, a trojan, etc.). The assignment of a reputation to a user may be performed based on an evaluation of the user's past behaviour as documented by a corresponding voting regarding this user by other users of a communication network. For instance, reputation data of a user may be in the form of a conduct value estimated based on user opinions and/or user experiences and/or programmatic evaluation of communication and/or message patterns. A reputation may also be determined or at least influenced by the affiliation or membership of a user to a social network. For instance, when a user is included in a list of trusted communication parties of a social network stored in a database of the coordination entity and/or of the recipient entity, this may be considered as a positive reputation. Different reputation items or aspects may be combined for deriving overall reputation data. For instance, an average of different positive and negative reputation items may be estimated to compute the reputation data. Hence, the resulting reputation can not only be a “digital” value (i.e. good reputation “yes” or “no”), but can include more than two values (for instance “trusted”, “untrusted” and “trust level not decidable”) or can also include a numerical value within a range (for instance a percentage between 0 and 100%, a mark between 1 and 6, points between −1000 and 1000, etc.).

The term “identity” of the sender entity may particularly denote data related to the sender entity. In an embodiment, the identity may be a specific or concrete identity (such as a name) directly representing a person operating the sender entity. However, the term “identity” may also denote an abstract identity (such as an email address, an IP address, a relation to a company or to a support department of a company, etc.) being assigned indirectly to the sender entity. The identity of the sender entity may denote information which is uniquely or unambiguously correlated to the sender entity. However, the sender entity or a natural person operating the sender entity may have one or multiple identities, for instance may have one or multiple email addresses. The identity of the sender unit may be authenticated and may be a trusted identity.

According to an exemplary embodiment, a safe communication architecture may be provided in which a recipient of a communication message can easily and intuitively evaluate a risk whether the communication message is spam or not, based on a combination of two items of information: On the On the one hand, the recipient may download reputation information indicative of a reliability of the sender during communication over the communication network in the past. Such information may be taken from a reputation database in which identities of participants of the communication network can be ranked with a certain reputation, for instance reflecting the experience of other users of the network with the sender in the past. However, this criteria when taken alone may be not sufficiently accurate, and the reliability of such a reputation based spamming filter may be further refined by combining corresponding reputation information on a display with personalized profile data which can be also displayed to the recipient. The recipient may download both reputation data and user profile data from one or more communicatively coupled entities. Therefore, such reputation and user profile data do not have to be permanently stored locally by the recipient. Any update or change of such data only has to be managed centrally by the coordination entity, and not in a distributed way at each node of a network. The user profile data (for instance a photo of the sender) may be provided by the sender to the coordination entity together with her or his identity upon registration in the communication system. Hence, the combination of the display of a reputation of a user and the display of user profile data may give a recipient user a fast, easy, reliable and intuitive impression of the trustability of a communication message.

In the following, further embodiments of the coordination entity will be explained. However, these embodiments also apply to the sender entity, to the recipient entity, to the communication system, to the method, to the program element and to the computer-readable medium.

The determining unit may be configured for determining the reputation of the sender entity by querying a reputation database based on the identity. In other words, the identity of the sender entity (provided during registration) may be used as a search criteria for retrieving user reputation data from a database such as a mass storage device.

The reputation database (which may have storage capabilities and may be realized as a mass storage device, for example) may store reputations for multiple entities (such as a large number of communication parties in the network), the reputations being provided by users of the communication network based on a previous experience with a corresponding one of the entities. For instance, each of the users may be enabled to provide a ranking for other users of the communication network regarding the exchange of communication messages with this user in the past. In case of bad experiences, for instance when a spamming mail was received from a sender, this may result in a bad ranking. In case of good experiences, a good ranking may be the consequence, for instance since a user provides a list of reliable users to such a database. The reputation database may be part of the coordination entity, or may be a separate storage device to which the coordination entity may have access. The reputation of a user may change over time, for instance since a behaviour of the user has changed. Thus, the reputation may be permanently updated.

Additionally or alternatively, the reputation database may store reputation data for multiple communication entities, the reputations being provided in accordance with a membership of a corresponding one of the communication entities to a social network. Hence, the fact that a user belongs to or is a member of a trusted (or untrusted) community may have an influence on the classification of such a user to have a good reputation (or a bad reputation).

The reputation database may store reputations for multiple communication entities, the reputations being determined (particularly calculated in accordance with a predefined algorithm) based on user and/or automatically evaluated feedback provided by users via the communication network and representing an experience of users with respective ones of the multiple communication entities. The term automatically evaluated feedback may denote that automatic feedback can also have an impact on the reputation (e.g. from spamtraps). For example, users of the communication network may (qualitatively or quantitatively) evaluate individual communication entities or persons operating such communication entities in the light of their previous behaviour in the communication network. In an embodiment, a user may provide the information that an individual communication entity is a trusted entity (in view of a positive experience of the voting user with this communication entity). It is also possible that a user having previously provided a positive evaluation of a communication entity later revokes or modifies the evaluation after a new (for instance less positive or negative) experience with this communication entity. Thus, an evaluation representing a good relation to a communication entity may also be modified over time allowing for a dynamic update of the reputation data. In another embodiment, a user may provide the information that an individual communication entity is an untrusted entity (in view of a negative experience of the voting user with this communication entity). In a further embodiment, exclusively a positive voting is possible. In a further embodiment, exclusively a negative voting is possible. In a further embodiment, both a positive voting or a negative voting is possible. Hence, users may vote, and the coordination entity may calculate reputation data from the votings in a user-specific way in accordance with a predefined calculation scheme. In a simple embodiment, such a calculation scheme may be the addition of “+1” to the reputation of a communication entity as a result of a positive voting, and the reduction of the reputation by “−1” as a result of a negative voting. However, many other calculation schemes may be applied as well.

The coordination entity may be realized as a plurality (for instance two, three, four or more) of separate servers. Such servers may be communicatively coupled to one another to enable data exchange between the servers. They may be located remotely with respect to one another. Particularly, the plurality of separate servers may store the user profile data and/or the reputation at least partially redundantly. For instance, user profile data and/or the reputation data corresponding to a respective jurisdiction (for instance the US) may be stored on a separate server being easily accessible for communication entities located within this jurisdiction. Additionally or alternatively to the jurisdiction, the partially redundant storage may also be managed in accordance with one or more other criteria.

In the following, further exemplary embodiments of the sender entity will be explained. However, these embodiments also apply to the coordination entity, to the recipient entity, to the communication system, to the method, to the program element and to the computer-readable medium.

The message sending unit may be configured for sending the communication message to the recipient entity with a signature indicative of the identity. In the context of this application, the term “signature” may relate to a data section (such as a textual portion) of an email or another communication message indicative of a sender of this communication message. Such a (for instance digital) signature may be obtained by applying a cryptographic procedure wherein, by using a private key (which may be secret), a number (for instance a so-called digital signature) may be calculated. The creatorship and the affiliation of the digital signature to the communication message can be checked by any other communication party by applying a public key (which may be publically available and not secret) to the signature. When a recipient entity receives the message with a message body and the signature, the analysis of the signature may be the first check of the reliability of the message. According to an exemplary embodiment, the unsuccessful analysis of the signature may be sufficient to reject the communication message. Only upon verifying the correctness of the signature, the communication message may be further processed and displayed together with reputation data and user profile data. This may allow to further increase reliability of the system. In an embodiment, the signature can be used to confirm the authenticity of a transmitted identity.

In the following, further exemplary embodiments of the recipient entity will be explained. However, these embodiments also apply to the coordination entity, to the sender entity, to the communication system, to the method, to the program element and to computer-readable medium.

The recipient entity may further comprise a signature evaluation unit configured for evaluating a signature of the communication message, the signature being indicative of the identity. Thus, when the recipient entity has received a signed communication message, the signature may be checked by the recipient entity to verify the correct identity of the sender entity.

The signature evaluation unit may further be configured for classifying the communication message as invalid in case that the evaluation of the signature fails. Thus, a wrong signature alone may be sufficient for refusal of the communication message so that the consequence can be that this communication message is transferred to a spam folder.

Alternatively, it is also possible that when the verification of the signature fails, the recipient entity displays the communication message in an inbox folder, however without profile data and without reputation data.

Still referring to the previously described embodiment, the signature evaluation unit may be configured for inhibiting the receiving of the user profile data and of the reputation of the sender entity in case that the evaluation of the signature fails. Therefore, when the signature is not verified, it is no longer necessary that traffic is generated over a communication network for receiving user profile data and reputation by contacting a coordination server. This allows for an efficient use of processing and storage resources of the communication system.

The display unit may be configured for graphically displaying the reputation. For instance, the display unit may be a monitor or the like (for instance a liquid crystal display, a cathode ray tube, a plasma display device or the like). In an example in which the communication message is an email, when a user of the recipient entity checks her or his emails in an email client, a click on an email may open a computer window which shows a graphical indication of the reputation. This may be a numeric value, for instance a percentage, being quantitatively indicative of the reliability of the user of the sender entity. It is also possible to display the reputation as a bar plot since this is a very intuitive way of reporting to the user at a glance whether the communication message is reliable or not. For instance, a very short bar may indicate a low degree of reliability, a very long bar may indicate a high degree of reliability. The reputation may also be displayed using a color code wherein the color may be indicative of the reputation. For example, a green button may indicate trustability of the user of the sender entity, a red button may indicate untrustability of the user of the sender entity, and a yellow button may indicate that trustability of the user of the sender entity is difficult or impossible to be decided. Hence, red, green and yellow may have a similar (and therefore intuitive) meaning as the colors of a traffic light.

The display unit may be configured for simultaneously displaying the user profile data and the reputation together with the communication message. In other words, user profile data, reputation and communication message may be displayed on the same computer window. Such a window may be considered as a two dimensional object arranged on a desktop. For instance, in one and the same window of a window-based browser, the message, the reputation and the user profile may be displayed at the same time so that it is very convenient for a user to see the message content, information regarding the person having sent the message and an evaluation of the trustability of this person.

The recipient entity may comprise a classification unit configured for classifying the communication message based on the reputation. Multiple classes of communication messages may be defined, wherein each class may for instance be assigned to an email folder in which the email message may be shifted if it belongs to the respective class. For instance, the downloaded reputation data may be analyzed regarding one or more predefined criteria for a decision of the recipient entity to which class the message should be classified (for instance whether a communication message should be treated as a regular email or should be shifted to a spam folder). Thus, the classification may be used as a filter criteria regarding spam. This spam filter criteria may be the only one or may be combined with one or more further filter criteria, for instance a text based filter criteria. Text or content filtering techniques may check on typical spam words, URLs that lead to known spam websites, invalid email formats or known fingerprints of spam mail bodies. In an embodiment, this content filtering technique may be combined with a delivery source filtering method checking for invalid sending IPs, for instance using a reputation of a user from a reputation database for evaluating the risk of a spam mail.

In an embodiment, a “black-white-listing” may be implemented for a user. In a scenario in which an email is received from an unknown identity, this email may be displayed in a specific representation mode, for instance in grey color. Only upon specific request, the recipient can receive the profile and reputation data and can trust these data. Only subsequently, the profile data may then be displayed as described above, for instance with a traffic light code. Such a black-white listing may provide a social network component providing for a link between different users.

In the following, further exemplary embodiments of the method will be explained. However, these embodiments also apply to the coordination entity, to the sender entity, to the recipient entity, to the communication system, to the program element and to the computer-readable medium.

In an embodiment, the identity of the sender unit may be an authenticated identity. This embodiment relies on the highly advantageous combination of the verification of an authenticated sender identity with the provision of reputation data and user profile data. This may render the communication system more secure and may make forgery of the identity and of the assigned user profile data more difficult or even impossible. When the profiles are based on an authenticated identity of the sender entity, it can be made very difficult or almost impossible that an unauthorized party of the communication network provides profile data related to another person party and therefore mimics another entity's identity. Consequently, it may be ensured that profile data provided by the system according to the described embodiment in fact relate to the sender entity. For instance, this can be ensured by a signature which may be added to the sent communication message. For instance during the communication between the sender entity and the recipient entity, the transmission of a signature together with the communication message may allow the recipient unit to confirm that the signature is correct and that hence the sender can be considered as an authorized sender. This verification can then also ensure that during the communication of the recipient entity with the coordination entity, profile data related to an authenticated user is downloaded. Such profile data may for instance be transmitted from the coordination entity to the recipient entity in an encrypted manner (for instance SSL encrypted) and/or using the signature. Since the verification of a signature may require a key (for instance a public key or any other code), the authenticated identity of the sender entity may be verified. With such an architecture, it may be prevented that an unauthorized party provides profile data of another communication party, for instance by using another one's email address.

In an embodiment, the communication message may be an email. An email or electronic mail may be denoted as an item of worldwide electronic communication in which a computer user can compose a message at one terminal that can be regenerated at the recipient's terminal when the recipient logs in. However, also other kinds of electronic communication messages may be handled according to exemplary embodiments, such as SMS (Short Message Service) messages, MMS (Multimedia Messaging Service) messages, etc. In another embodiment, it is also possible that a user profile in combination with reputation data are displayed on a display of a phone such as a mobile phone in case of an incoming call. Based on these data items (which may, in an embodiment, be retrieved from a remote server and not stored locally on the mobile phone), a user of the phone may then decide whether the phone call is answered or not. In case of a low reputation (for instance indicating that the caller is an untrusted party) of the caller, the user will receive this information before answering the call. In such an embodiment, the user profile data and the reputation may be displayed in combination with a telephone number or an assigned identity (such as a name) of the caller. The phone may download both the user profile and the reputation from the coordination entity upon receipt of the incoming call.

In an embodiment, the communication may be in accordance with a Domain Key Identified Mail (DKIM) architecture. In DKIM, a public key may be deposited in a DNS (domain name system) server. The DNS server may be a different one or the same server as the coordinating server providing the user profile data and the reputation data to the recipient entity. A recipient entity desiring to validate a signature of a received communication message may then contact the DNS server to obtain the public key for validation of the signature. With successful validation of the DKIM signature a authenticated identity can be derived from the DKIM user and domain parts. This DKIM identity can be directly used by the coordinating entity.

In Domain Key Identified Mail communication (DKIM communication), a DKIM reputation database may be used in which identities of spammers are collected that are sending DKIM valid mails (to spam traps). These reputation data may be provided as a DNS blacklist which is accessible to anybody and can be used as a spam filter criteria. Such an embodiment may implement a DKIM signature check which will check a DKIM signature on message delivery and may notify a user when a signature is invalid. A DKIM notification service may send an email to a user when a mail domain is listed in the blacklist. With a DKIM reputation query, a user can check an own DKIM reputation. This can be done by entering an email address and a domain name of a signing party. DKIM is included in the industrial standard RFC 4871. In order to reduce the risk of spam and phishing emails reducing the trustability of email communication, emails may be automatically signed with a signature based on the DKIM standard. Hence, in a DKIM system, verified spam mails may be collected, and their senders may be added to a reputation database that can be used in spam mail filtering. A bad score may be given to DKIM spammers, and a slightly good score to other, good DKIM senders.

As an alternative to DKIM, a validation of a signed communication message (sent from the sender entity to the recipient entity) by the recipient unit may be performed based on a public key which is included as part of the transmitted communication message in the form of a verifiable certificate of a public key infrastructure (PKI). Hence, it may be dispensable to download such a public key from a dedicated server in such an embodiment, and the identity can be authenticated.

In another embodiment, a communication may be performed in accordance with Kerberos. Kerberos may be denoted as a computer network authentication protocol which may allow nodes communicating over a non-secure network to prove their identity to one another in a secure manner. Such a technology may be particularly applied to a client server system and provides mutual authentication. Both the user and the server may verify each others identity. Kerberos may implement symmetric key cryptography and may require a trusted third party. A Kerberos architecture may be particularly appropriate in an intranet.

The user profile data may comprise image data showing the user operating the sender entity, image data including a photo of the user operating the sender entity, image data including a logo assigned to the user (or a company or association to which the user belongs), text data having a relation to the user, audio data having a relation to the user, audiovisual data having a relation to the user, multimedia data having a relation to the user, a link to a node of a communication network (for instance a link to a homepage of the user) and/or contact information for contacting the user. More generally, a generally, a user profile may be denoted as the collection of personal data associated to a specific user. The profile may refer therefore to the electronic representation of a person's identity or may be an abstract profile which is only indirectly linked to a person (for instance a profile of a company to which a person belongs). Such profile data may be supplied in combination with the identity of the user by the user upon registering at the coordination entity.

When the recipient entity queries the coordination entity after receipt of a message to derive reputation data, also profile data may be sent from the coordination entity to the recipient entity. The reputation data may be indicative of a rating of a behavior of a user of the sender entity regarding a previous communication over the communication network. Thus, a voting may be contributed for each user of a communication network so that the total opinion of the users regarding a specific participant may be reflected in the reputation database.

The reputation data may be indicative of a probability that the communication message of a user of the sender entity is a spam message. Therefore, the reputation data may be used as a spam filtering criteria as well.

The communication network may be the public Internet. In the public Internet it is very important that spam mails are suppressed because here it is very difficult to control spamming activities. However, it is also possible that the system is implemented on an intranet, for instance a network operated by an institution or a company. Here, a central server may be used as a trusted entity which manages the user profiles as well as the reputation.

The sender entity and/or the recipient entity may comprise an email client or may be communicatively coupled to an email server providing an email client. Such an email client may be a browser via which a user may monitor her or his emails regularly. During such a monitoring, a user has only few time to decide whether an email is read in detail or is refused as spam. The intuitive combination of user profile data and reputation may be a considerable simplification for a user allowing to decide in a very short time whether an email is considered as a spam or not.

In an embodiment, DKIM verification may be used as a spam filter criteria. Particularly, a DKIM signed email may be used as a basis for an identity based filtering. In other words, this may allow evaluating whether an email originates from an untrusted user or not. The identity may be included in the email, for instance in an email header verifiable by a checksum or the like. If the checksum is okay, the email message may be basically accepted and can be displayed in an inbox folder of an email client. However, a more detailed analysis of the reliability of such an email may be performed by considering as well the reputation of the user provided by the reputation database and user profile data displayed simultaneously. In other words, the identity may be linked to profile data for the sake of spam filtering. Thus, components from a social network (certified sender) may be used. For this purpose, a database may be accessed which includes spam relevant information as well as user profile data.

Exemplary embodiments of the invention are based on an identification system such as the Domain Key Identified Mail (DKIM) which allows the identification of systems via which an email has been transferred over a global mail network. In this context, asymmetric cryptographic methods may be applied. Such an identification system may be combined with a reputation database. Using DKIM, it is possible to assign reputations to DKIM identities, for instance to rank spammers with a low reputation in order to reduce a probability that a corresponding email is not classified as a spam email.

The aspects defined above and further aspects of the invention are apparent from the examples of embodiment to be described hereinafter and are explained with reference to these examples of embodiment.

The invention will be described in more detail hereinafter with reference to examples of embodiment but to which the invention is not limited.

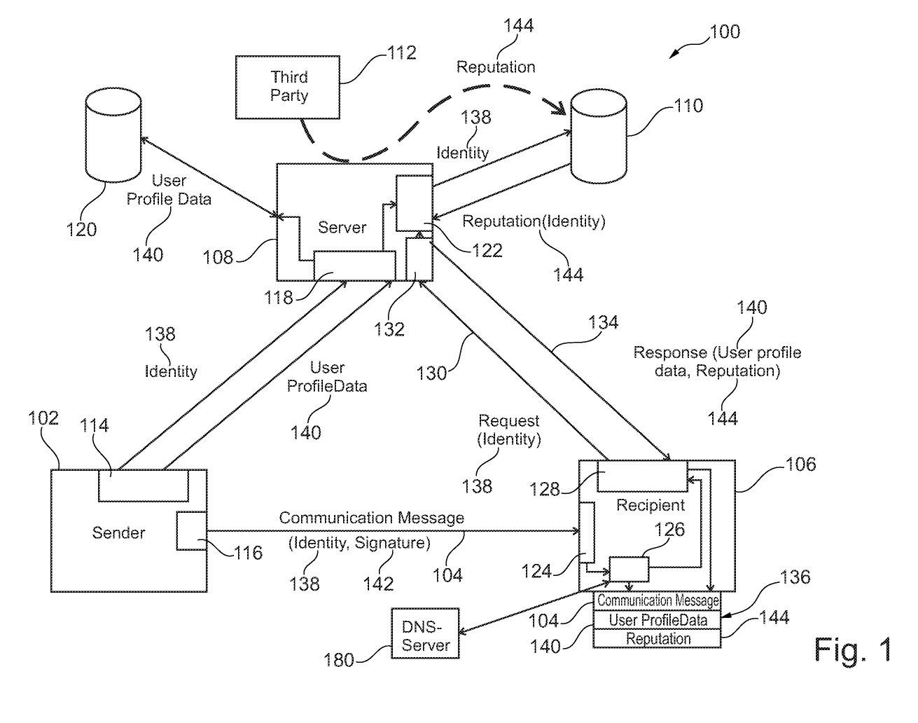

FIG. 1 illustrates a communication system according to an exemplary embodiment of the invention.

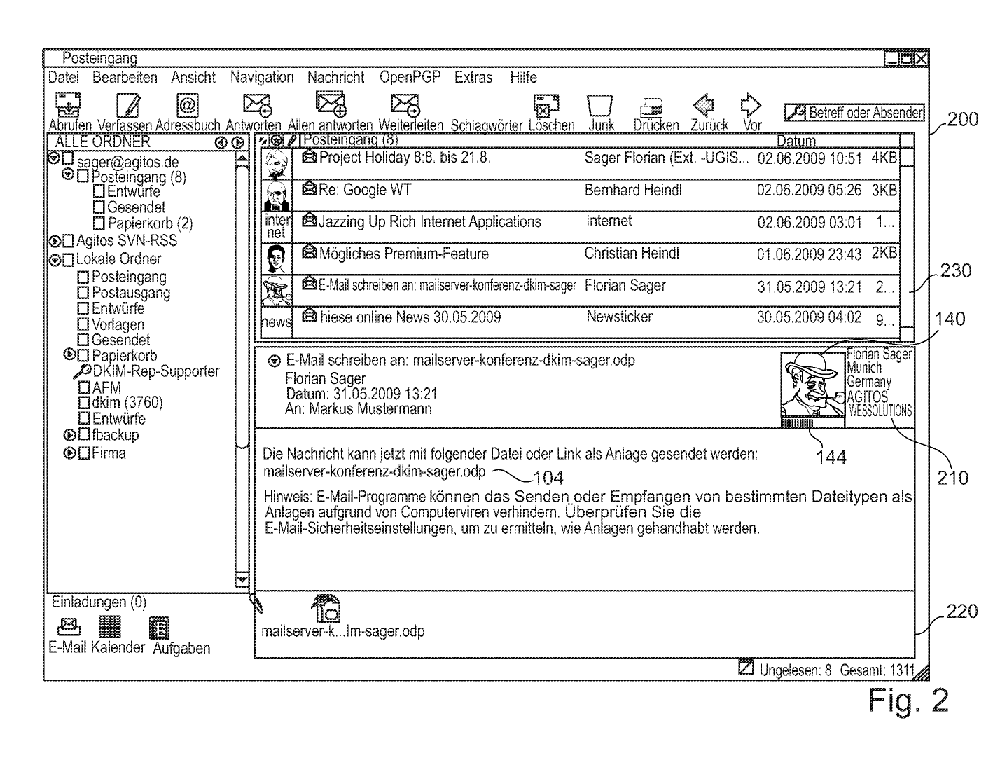

FIG. 2 illustrates a display of an email client such as Mozilla Thunderbird in which an email is displayed as a combination of a message text, profile data of a user as well as a user reputation.

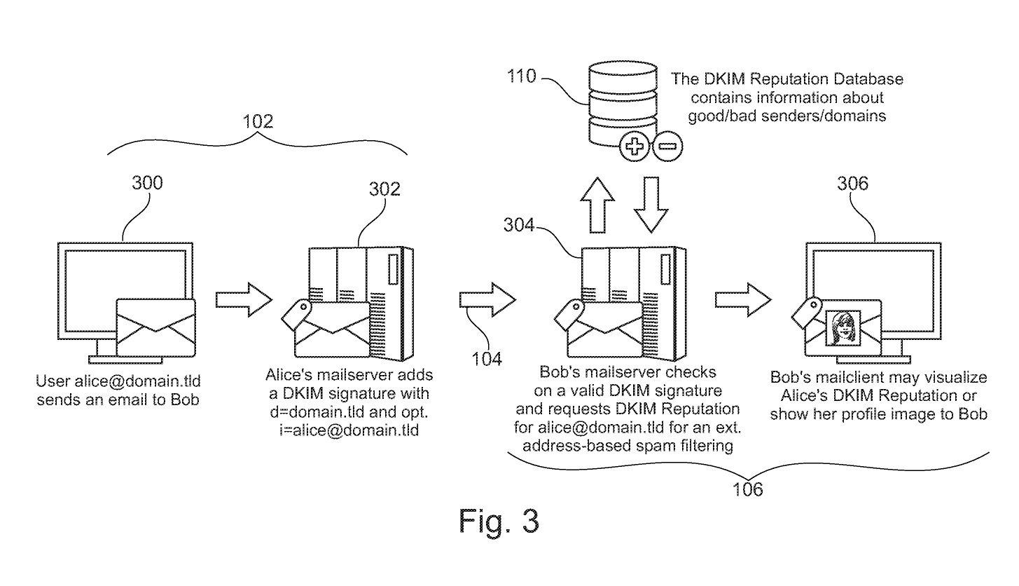

FIG. 3 schematically illustrates communication between a sender entity, a recipient entity and a coordination entity in a communication system based on DKIM according to an exemplary embodiment.

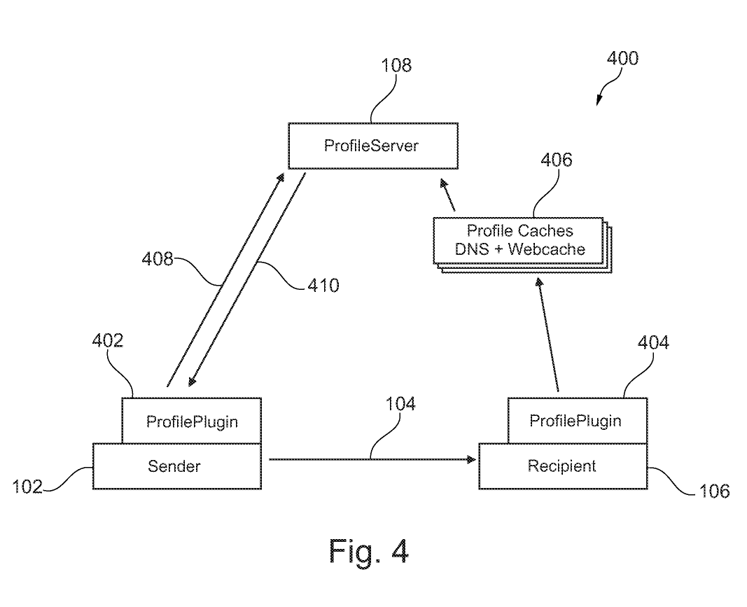

FIG. 4 illustrates a system architecture of a communication network according to an exemplary embodiment.

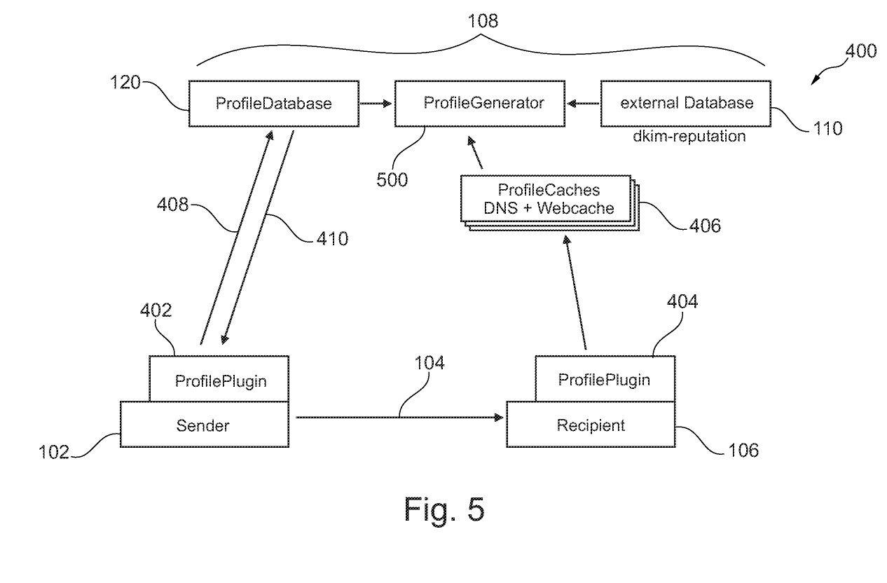

FIG. 5 is a more detailed view of the communication architecture of FIG. 4.

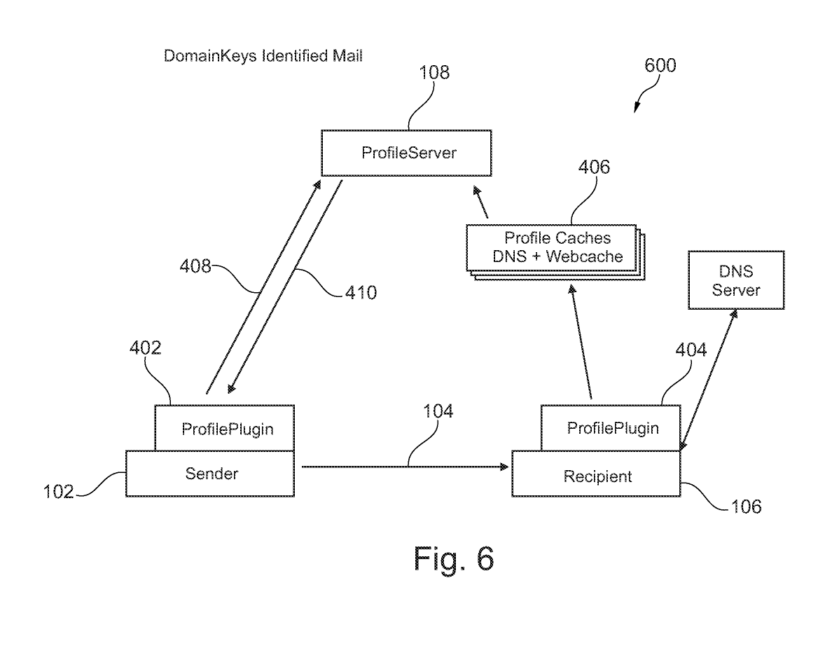

FIG. 6 illustrates a DKIM communication network according to an exemplary embodiment of the invention.

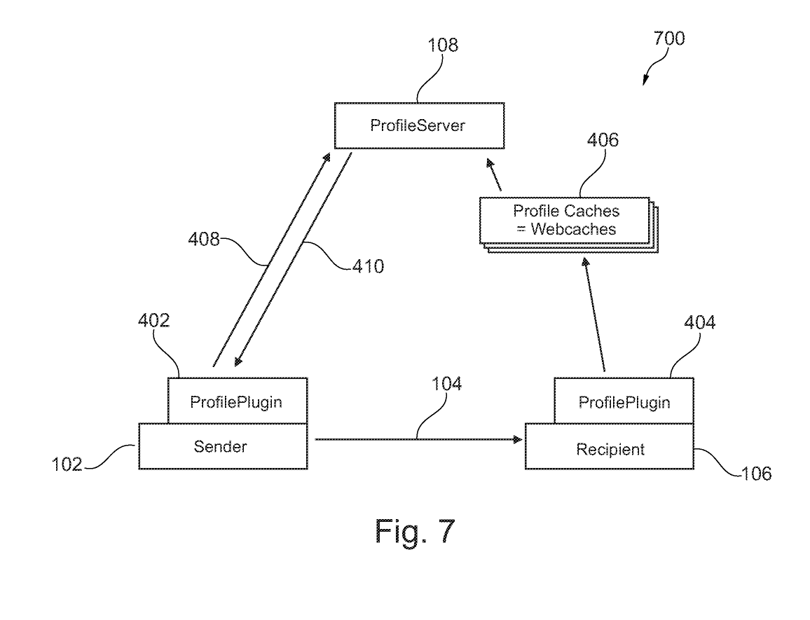

FIG. 7 illustrates a communication system according to an exemplary embodiment of the invention in which a public key for validating a signature of an email is included in the email.

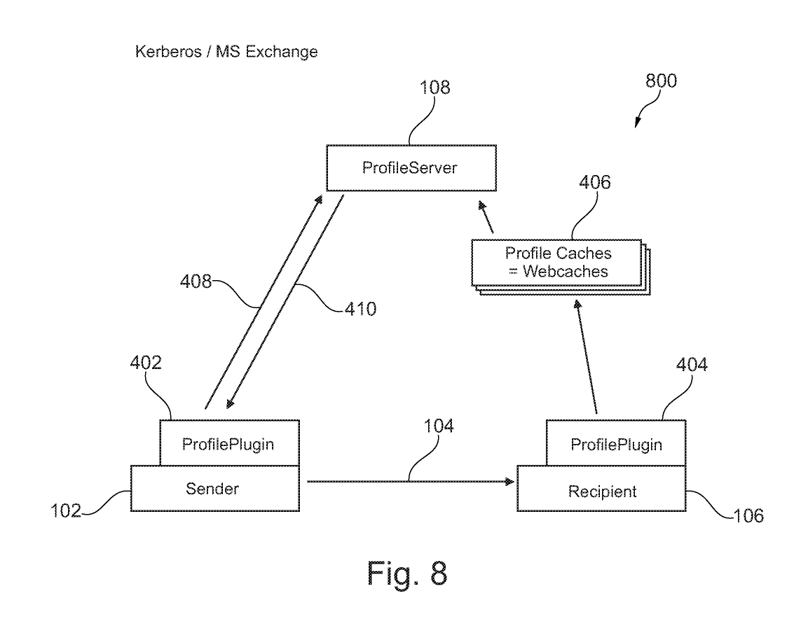

FIG. 8 illustrates a Kerberos communication system according to an exemplary embodiment of the invention.

The illustration in the drawing is schematically. In different drawings, similar or identical elements are provided with the same reference signs.

In the following, referring to FIG. 1, a communication network 100 according to an exemplary embodiment of the invention will be explained.

The communication network 100 comprises a sender entity 102 (for instance a personal computer operated by a sender user) for sending a communication message 104 to a recipient entity 106 (for instance a further personal computer operated by a recipient user). The communication network 100 furthermore comprises the recipient entity 106 receiving the communication message 104 from the sender entity 102 over the communication network 100. Moreover, a server 108 acting as a coordination entity is provided for coordinating communication between the sender entity 102 and the recipient entity 106 over the communication network 100.

When the sender entity 102 sends the communication message 104 to the recipient entity 106, a message transfer server such as an email server (not shown in FIG. 1) of the sender entity 102 and a message transfer server such as an email server (not shown in FIG. 1) of the recipient entity 106 as well as further message transfer servers (for instance intermediate email servers) may be provided as well in the communication path between the sender entity 102 and the recipient entity 106. Such message transfer servers may be separate entities in addition to entities 102, 106 or may be part of entities 102, 106 and integrated therein.

Previous experiences of users of the communication network 100 with the sender entity 102 are characterized by a reputation value 144 which is stored in a reputation database 110 such as a mass storage device. The reputation 144 of the sender entity 102 is indicative of the reliability and the trustability of the sender entity 102 in previous communication procedures. Any third party 112 having communicated with the sender entity 102 in the past, i.e. having exchanged communication messages with the sender entity 102, may provide a ranking of the sender entity 102 regarding the trustability of this sender entity 102. If the sender entity 102 has sent spam messages in the past to the third party 112, the third party 112 may evaluate the reputation 144 of the sender entity 102 in a negative way. In contrast to this, if the previous communication between the third party 112 and the sender entity 102 has been successful and reliable in the past, the third party 112 may evaluate the sender entity 102 in a positive manner by providing respective reputation reports to the reputation database 110. The reputation database 110 stores reputation data 144 also for a plurality of other users of the communication network 100.

The sender entity 102 comprises a registration trigger unit 114 configured for triggering a registration of the sender entity 102 at the server 108 by sending registration data indicative of an identity 138 of the sender identity 102 and sending user profile data 140 of the sender entity 102 to the server 108. In other words, an identity 138 (or data allowing to derive an identity 138) of the sender entity 102 is supplied to the server 108 in connection with user profile data 140, for instance a photo of a person operating the sender entity 102.

Moreover, the sender entity 102 may comprise a message sending unit 116 for sending the communication message 104 including the identity 138 of the sender entity 102 and including a signature 142 to the recipient entity 106. The identity 138 may be the domain or the email address or the URL or the IP address or a sender specific ID of the sender entity 102. The signature 142 may be a DKIM signature allowing the recipient entity 106 to decide whether the communication message 104 is a DKIM valid message, by analyzing the signature 142. Additionally or alternatively, other signatures may be implemented as well.

As can further be taken from FIG. 1, the server 108 comprises a registration receipt unit 118 configured for receiving the registration data from the sender entity 102 indicative of the identity 138 of the sender entity 102 and comprising the assigned user profile data 140 of the sender entity 102.

The server 108 may comprise or may communicate with a user profile database 120 such as a mass storage device for storing the user profile data 140 supplied from the registration trigger unit 114 of the sender entity 102 to the server 108. In the embodiment of FIG. 1, the user profile database 120 and the reputation database 110 are shown as separate databases, but may also be realized as one common database or one common mass storage device.

In addition to the registration receipt unit 118, the server 108 further comprises a determining unit 122 for determining or retrieving the reputation 144 of the sender entity 102 by querying the reputation database 110 based on the identity 144 serving as a search criteria for querying the reputation database 110. In other words, when the identity 138 is used as a search criteria for querying the reputation database 110, the corresponding reputation 144 assigned to this identity 138 may be returned to the server 108.

The recipient entity 106 comprises a message receiver unit 124 for receiving the communication message 104 from the sender entity 102 including the identity 138 of the sender entity 102 and including the (optional) signature 142.

A signature evaluation unit 126 (optional and only present when the embodiment of FIG. 1 is operated with a signature architecture) may then verify the signature 142 of the communication message 104. For this purpose, the signature evaluation unit 126 may bidirectionally communicate with a DNS (Domain Name System) server 180. If the signature evaluation unit 126 identifies the communication message 104 to be invalid due to a wrong signature 142, the communication message 104 may be directed into a spam folder or may be classified as spam. In other words, a correct signature 142 may be the qualification for the communication message 104 to be further evaluated or considered as a valid email.

If the communication message 104 has passed successfully the signature evaluation, a request unit 128 is activated which is configured for requesting transmission, from the server 108, of the user profile data 140 and the reputation data 144 assigned to the sender entity 102. The corresponding request 130 is received by a user data transmission unit 132 of the server 108 which is configured for transmitting the user profile data 140 after having queried the user profile database 120 (using the identity 138 as a search criteria) and the reputation data 144 (using the identity 138 as a search criteria) after having queried the reputation database 122. Thus, in reply to the request 130, a response 134 is sent from the user data transmission unit 132 to the user data receiver unit 128.

Subsequently, a display unit 136 of the recipient unit 106, for instance a liquid crystal display unit or a cathode ray tube, displays the user profile data 140 and the reputation 144 together with the communication message 104. Thus, the message 104 may be presented to a human user visually in combination with a profile of the user, i.e. a profile of the sender 102 so as to allow a social networking with an email. In addition to this, also the reputation 144 of the sender entity 102 is displayed at the same time. This may overcome the conventional problem of a poor trustability of message-based communication in view of activities such as address spoofing or phishing. It is possible that the sender entity 102 is visualized by the user profile data 140. Furthermore, spam and commercial mails may be removed by filtering since the IP address of the sender entity 102 (and the additional information derived therefrom) may be used as a trust anchor. Thus, the email 104 may be personalized by visually displaying a user profile 140 (for instance images, multimedia, contact information or the like) when monitoring an email 104. In addition, the reputation 144 of the sender 102 is assigned to the user identity 138. Exemplary embodiments may allow to constitute a social network of email contacts by managing confidential relationships. Hence, the described embodiment allows social networking with emails.

FIG. 2 illustrates a screenshot 200 of an email client such as Mozilla Thunderbird.

FIG. 2 illustrates the communication message 104, i.e. a text content thereof, in combination with a photo 140 (optionally also with a logo such as a corporate symbol 210) as an example for user profile data. In addition to this, a bar plot 144 is shown being indicative of a reputation value of the sender, i.e. of the person shown in the photo 140.

Additionally or alternatively to the bar plot 144, it is also possible that any other qualitative or quantitative measure for the reputation is displayed. For instance, a traffic light image (or a traffic light like image) may be displayed in which a red, yellow or green spot is displayed to indicate that the reputation of the user is trusted (for instance green), untrusted (for instance red) or undecidable (for instance yellow).

The simultaneous display of the content of the communication message 104 with the user profile 140 and the reputation 144 allows a user to easily decide intuitively whether the sender 102 is reliable or not.

In an alternative embodiment, the reputation 144 and the user profile 140 are not only indicated in a window 220 showing the entire email data 104, but also in an overview window 230 showing a list of various available emails.

In order to implement the reputation 144 and user profile 140 display feature in an email client such as Mozilla Thunderbird or the like, it is possible to add a plug-in which provides this additional service. It is also possible that the corresponding software is directly implemented in the source code of the email client for providing the reputation 144 and user profile 140 display feature.

FIG. 3 schematically illustrates a DKIM procedure.

A user may operate a terminal 300 communicating with a corresponding mail server 302. Entities 300 and 302 may represent the sender entity 102 in FIG. 1. A corresponding DKIM signed email 104 may then be sent to a mail server 304 of a recipient communicating via a user terminal 306. Entities 304 and 306 may represent a recipient entity 106 as shown in FIG. 1. Reputation database 110 may be queried by the recipient entity 106 to derive further information regarding the reputation 144 of the sender entity 102.

FIG. 4 illustrates a communication system 400 according to another exemplary embodiment.

A computer may be equipped with a profile plug-in 402 to form the sender entity 102 communicating with the profile server 108 and the recipient 106 which may also be a computer equipped with a profile plug-in 404.

Moreover, a profile cache 406 may be provided. Profile cache 406 may include a copy of data (such as reputation data 144 and/or user profile data 140) which data is also stored in the profile server 108. For instance, all reputation data 144 and user profile data 140 may be centrally stored at the profile server 108, whereas profile cache 406 only includes a subset of the reputation data 144 and/or user profile data 140. Such an architecture may render the system appropriate also for very large numbers of users. For example, profile server 108 may be located in Germany and profile cache 406 may be located in the US. For users in the US, profile cache 406 may be more easily or faster accessible as compared to profile server 108 so that data relevant for US users may be copied into profile cache 406.

As illustrated with reference numeral 408, the profile plug-in 402 may communicate with profile server 108 for a first time registration, for instance also including profile updates, registering of present email identities (user name and password, authentication at the profile server 108). In response to the message 408, a profile ID may be supplied from the profile server 108 to the profile plug-in 402 by a communication message 410, if necessary in connection with further data such as key pairs.

Email 104 may be transmitted from the sender entity 102 to the recipient entity 106. If necessary, email headers may be inserted before the transmission of the email 104 for a qualified signature 142 or an additional identification on the recipient 106 side.

On the recipient side 106, user-based identities 138 may be recognized in the email 104, if necessary a profile ID may be assigned.

In the communication between the profile plug-in 404 and the profile cache 406, the profile ID may be resolved and the profile data may be transmitted. The profile data may include texts, URLs, multimedia files, etc.

FIG. 5 is a more detailed illustration of a communication system 400 shown in FIG. 4. The server 108 comprises the profile database 120 for providing user profile data 140, an external database 110 for providing reputation data 144 and a profile generator 500 which may have processing resources.

The profile generator 500 may be configured for composing profile data 140 such as images, URLs, multimedia data, and individual reputations 144.

FIG. 5 illustrates that one or more external data sources may be added to the communication architecture according to an exemplary embodiment.

In a communication system 600 shown in FIG. 6, the system is adapted for a DKIM communication. In this context, the transmission of the email 104 may include the insertion of a DKIM signature by a direct provider (first party signature). Within the recipient 106/the profile plug-in 404, a DKIM validation and, if necessary, a calculation of the DKIM identity (from a DKIM-header comprising e.g. the i-parameter) may be performed. The profile plug-in 404 and the profile cache 406 may communicate to resolve the profile ID and to trigger transmission of the profile data. In the communication message 408, available email identities may be registered by email transmission to the profile server 108 (user name plus password, authentication at the profile server 108).

FIG. 6 illustrates that entities 106, 404 communicate with DNS server 180. For instance, entities 106, 404 may download from DNS server 180 a public key based on an identity of a mail server of the sender entity 102. Based on this key, the signature may be verified by the recipient entity 106. In other words, an identity of the mail server on domain level may be correlated with an identity of the sender on user level.

A communication system 700 shown in FIG. 7 differs from the communication system 600 shown in FIG. 6 in that FIG. 7 relates to a so-called User Key Identified Mail (UKIM) architecture. The transmission of the email 104 is performed with the insertion of an email header prior to the email transmission including an UKIM signature via From, To, Timestamp, Reference, Body-Hash, Body-Length and including the certificate. At the side of the recipient entity 106/profile plug-in 404, the UKIM signature is validated. After examining the certificate via a public key infrastructure and verification of the UKIM signature the profile ID included also in the certificate may be accepted. In a communication between entities 404 and 406, the profile data are transmitted. In the communication 408, a first time registration at the profile server 108 is performed, if necessary profile updates are transmitted (user name and password, authentication at the profile server 108). In the communication message 410, a profile ID is assigned, a private key and a certificate with a common name is assigned, which is the profile ID.

In the embodiment of FIG. 7, a public key of the sender entity 102 is included in the email 104. Hence, a signature is verifiable by the recipient 106 without the necessity of contacting a DNS server (as in FIG. 6). Thus, a recipient entity 106 is not dependent on whether such a DNS server supports a used communication architecture such as DKIM or not. Therefore, including a public key for signature validation directly in the email may allow to provide a more flexible system. In FIG. 7, recipient entity 106 may therefore validate communication message 104 without the need to access an external database.

A communication system 800 shown in FIG. 8 relates to a Kerberos enabled environment.

In a communication message 408, a user profile is created at a domain controller, if necessary profile updates are communicated. Communication message 410 relates to the assignment of a profile ID, i.e. a user name. When transmitting the email 104, an email header is introduced by a mail server (based on a Kerberos authentication), a so called authentication header comprising a security token. At the side of the recipient entity 106/profile plug-in 404, the security token authentication header is validated by the client. Here, From-Header may be used as a profile key or identity. In the communication between the profile plug-in 404 and the profile cache entity 406, the profile data is transmitted (based on the From-Address).

The Kerberos architecture of FIG. 8 is particularly appropriate for an Intranet being limited to a defined number of communication nodes in contrast to the unlimited public Internet. For instance, the communication network shown in FIG. 8 can be operated in a Microsoft Exchange environment. In such a scenario, an Exchange Server knows which user has sent the communication message due to the Kerberos authentication. The server may attach a security token in an Authentication header of the communication message indicative of the fact that this server has sent the communication message. Such a header may grant the trustability of the From header which may then be used for downloading data from a Profile Server.

An exemplary application of exemplary embodiments of the invention is company internal communication, for instance within a local network. For instance, an email identity may be verified by a trusted registration of the mail server of the network of the company. A profile storage may be performed in a a Microsoft Active Directory.

Another exemplary embodiment may relate to a global architecture. An email identity may be verified by the employment of DKIM (Domain Key Identified Mail, RFC 4871) or UKIM (User Key Identified Mail). The deposition of a profile in the web may be performed via a social network.

It should be noted that the term “comprising” does not exclude other elements or features and the “a” or “an” does not exclude a plurality. Also elements described in association with different embodiments may be combined.

It should also be noted that reference signs in the claims shall not be construed as limiting the scope of the claims.

1. A coordination entity for coordinating communication between a sender entity sending a communication message and a recipient entity receiving the communication message over a communication network, the coordination entity comprising:
a registration receipt unit configured for receiving registration data from the sender entity indicative of an identity of the sender entity and comprising assigned user profile data of the sender entity;
a determining unit configured for determining a reputation of the sender entity based on the identity;
a user data transmission unit configured for transmitting the user profile data and the reputation to the recipient entity for display of the user profile data and the reputation together with the communication message, the transmitting being triggered in response to a request of the recipient entity including the identity.

2. The coordination entity according to claim 1,
wherein the determining unit is configured for determining the reputation of the sender entity by querying a reputation database based on the identity.

3. The coordination entity according to claim 2,
wherein the reputation database stores reputations for multiple communication entities, the reputations being provided by users of the communication network based on a previous experience with a corresponding one of the communication entities.

4. The coordination entity according to claim 2,
wherein the reputation database stores reputations for multiple communication entities, the reputations being determined in accordance with a link of a corresponding one of the communication entities with other users in a social network.

5. The coordination entity according to claim 2,
wherein the reputation database stores reputations for multiple communication entities, the reputations being determined based on user and/or automatically evaluated feedback provided by users via the communication network and representing an experience of users with respective ones of the multiple communication entities.

6. The coordination entity according to claim 1,
comprising a plurality of separate and communicatively coupled servers, particularly a plurality of separate and communicatively coupled servers storing the user profile data and the reputation at least partially redundantly.

7. A sender entity for sending a communication message to a recipient entity over a communication network, the sender entity being characterized in the communication network by a reputation, the sender entity comprising:
a registration trigger unit configured for triggering a registration of the sender entity by sending registration data indicative of an identity of the sender entity and comprising assigned user profile data of the sender entity to a coordination entity to enable the coordination entity for determining the reputation of the sender entity based on the identity and for transmitting the user profile data and the reputation to the recipient entity for display of the user profile data and the reputation together with the communication message;
a message sending unit for sending the communication message including the identity to the recipient entity.

8. The sender entity according to claim 7,
wherein the message sending unit is configured for sending the communication message to the recipient entity including a signature to verify the identity.

9. A recipient entity for receiving a communication message from a sender entity over a communication network, the recipient entity comprising:
a message receiver unit configured for receiving the communication message from the sender entity including an identity of the sender entity;
a request unit configured for sending a request for user profile data and a reputation of the sender entity to a coordination entity, the request including the identity of the sender entity;
a user data receiver unit configured for receiving the user profile data and the reputation of the sender entity in response to the request from the coordination entity;
a display unit configured for displaying the user profile data and the reputation together with the communication message.

10. The recipient entity according to claim 9,
comprising a signature evaluation unit configured for evaluating a signature of the communication message, the signature verifying the identity.

11. The recipient entity according to claim 9,
wherein the display unit is configured for graphically displaying the reputation, particularly for graphically displaying the reputation as one of the group consisting of a bar plot, a color code, and a numeric value in case that the evaluation of the signature succeeds.

12. The recipient entity according to claim 9,
wherein the display unit is configured for simultaneously displaying the user profile data and the reputation together with the communication message in case that the evaluation of the signature succeeds.

13. The recipient entity according to claim 9,
comprising a classification unit configured for classifying the communication message based on the reputation.

14. A communication system for communicating over a communication network, the communication system comprising:
a sender entity of claim 7 for sending a communication message to a recipient entity over the communication network;
the recipient entity of claim 9 for receiving the communication message from the sender entity over the communication network;
a coordination entity of claim 1 coordinating communication between the sender entity and the recipient entity over the communication network.

15. A method of coordinating communication between a sender entity sending a communication message and a recipient entity receiving the communication message over a communication network, the method comprising:
registering the sender entity based on registration data indicative of an identity of the sender entity and comprising assigned user profile data of the sender entity;
determining a reputation of the sender entity based on the identity;
transmitting the user profile data and the reputation to the recipient entity for display of the user profile data and the reputation together with the communication message, the transmitting being triggered in response to a request of the recipient entity including the identity.

16. The method of claim 15,
wherein the identity of the sender unit is an authenticated identity.

17. The method of claim 15,
wherein the communication message comprises one of the group consisting of an email, an incoming telephone call, a Short Message Service message, a Multimedia Messaging Service message, and a message initiating a messenger chat.

18. The method of claim 15,
wherein the user profile data comprises at least one of the group consisting of image data related to the user, image data including a photo of the user, image data including a logo related to the user, text data, audio data, video data, audiovisual data, multimedia data, a link to a node of the communication network, and contact information for contacting the user.

19. The method of claim 15,
wherein the reputation data is indicative of a rating of a behaviour of a user of the sender entity regarding a previous communication over the communication network.

20. The method of claim 15,
wherein the reputation data is indicative of a probability that the communication message sent by the sender entity is a non-trusted message, particularly is a spam message.

21. The method of claim 15,
wherein the communication network comprises at least one of the group consisting of the public Internet and an intranet.

22. The method of claim 15,
wherein at least one of the sender entity and the recipient entity comprises or is communicatively coupled to a message transfer entity, particularly to an email client.

23. A computer-readable medium, in which a computer program of coordinating communication between a sender entity sending a communication message and a recipient entity receiving the communication message over a communication network is stored, which computer program, when being executed by a processor, is adapted to carry out or control a method according to claim 15.

24. A program element of coordinating communication between a sender entity sending a communication message and a recipient entity receiving the communication message over a communication network, which program element, when being executed by a processor, is adapted to carry out or control a method according to claim 15.
